(19) United States
(12) Patent Application Publication
(10) Pub. No.: US 2021/0323111 A1
(43) Pub. Date: Oct. 21, 2021

(54) Guiding Device, System and Method for Surface Treatment

(71) Applicant: Festool GmbH, Wendlingen (DE)

(72) Inventors: Nicolai Knecht, Pliezhausen (DE); Timo Bayer, Tübingen (DE); Philipp Oehler, Bad Krozingen (DE); Erik Schüssler, Leonberg (DE); David Grimm, Nürtingen (DE); Manuel Bäuerle, Filderstadt (DE); Michael Higelin, Köngen (DE)

(21) Appl. No.: 17/415,280

(22) PCT Filed: Oct. 22, 2020
(86) PCT No.: PCT/EP2020/079834

§ 371 Date: Jun. 17, 2021

(30) Foreign Application Priority Data
Dec. 23, 2019 (DE) 102019135777.2

(51) Int. Cl. B24B 23/00; B23Q 9/00; B24B 23/02

(52) U.S. Cl. CPC B24B 23/005; B24B 23/028; B23Q 9/0028

(57) ABSTRACT

The invention relates to a guiding device 100, a system comprising a guiding device and a tool 111 for surface treatment, a method for surface treatment with the guiding device 100 and a method for retrofitting a tool 111 with the guiding device 100. The guiding device 100 comprises at least one guide element 101, one angle device 102 and one connection arrangement 130 for connecting the guiding device to the tool 111. Furthermore, a predetermined angle between the plane 180 of the at least one guide element 101 and a plane of action 110 of the connectable tool 111 is set by means of the angle device 102. The guiding device 100 is furthermore characterised in that it is switchable between at least one flexible operating state and one rigid operating state.

### TECHNOLOGICAL BACKGROUND

The invention relates to a guiding device, a system comprising a guiding device and a tool for surface treatment, a method for surface treatment with the guiding device and a method for retrofitting a tool with the guiding device.

### Problems of the Invention

The use of automatic machines for surface treatment is known from the prior art. Electric sanding tools such as the belt sander or eccentric sander, for example, are widely employed in surface treatment. In the surface treatment of edges using hand-held eccentric sanders or similar machines, there is however the problem that the sanding tool tips over easily and, as a result, can produce undesired sanding damage such as sanding-through. In such cases, tried and tested hand-sanding is frequently relied upon.

A manual treatment with a sanding block is advantageous, for example, in complex treatment processes such as the intermediate lacquer sanding of edges. The intermediate lacquer sanding is the sanding that is performed after the first lacquering. This is intended to result in a smoothed surface. As a result of as uniform a sanding pattern as possible and low sanding tolerance, in addition the intention is to reduce the amounts of lacquer applied and to shorten the polishing process. The surface in this case must not be damaged. A manual treatment for the intermediate lacquer sanding is known as an inexpensive alternative compared to treatment on stationary machines. However, manual surface treatment with the hand sanding block has the disadvantage that it is associated with significant expenditure of time and produces more uneven or unreproducible sanding patterns than with an automatic sanding machine.

A rapid and accurate treatment of edges is possible in a stationary treatment centre. Here, however, there is the problem that sanding particles can be deposited, and therefore a treatment centre is more suitable for coarse sanding than for fine sanding work. Furthermore, there is the disadvantage of high investment costs. The known guiding devices of treatment centres require a large installation space compared to mobile sanding machines and are suitable in particular for the treatment of relatively small plates. In the case of large plates, however, there is still the problem that the bearing surface of the stationary machine is not sufficient. Therefore, a person has to guide the plate manually or roller blocks have to support the movement of the plate to be treated past the stationary sanding machine. While the manual guiding has the disadvantage that it leads to inaccurate results of the edges of the workpiece, there is still the problem that roller blocks can only be used on a level surface.

Therefore, there is a need to provide a mobile, compactly constructed and at the same time accurately working guiding device for sanding and polishing tools, in particular for edge sanding and for complex work like the intermediate sanding during lacquering. In this case, the aim is to combine the advantages of manual guiding with the advantages of stationary treatment.

Furthermore, the guiding device is intended to fulfil the following requirements: The guiding device should guarantee high precision in surface treatment and should be optimally settable as a function of the surface to be treated. In particular, it is desirable that the guiding device does not have a fixed connection for intermediate lacquer sanding. To produce precise geometries, however, a fixed connection is necessary, which means that a guiding device should command both a fixed and a non-fixed operating mode. At the same time, the guiding device should be simple to operate.

The connection of the tool to the guiding device is intended to be detachable, wherein the connection arrangement should also be adaptable in such a way that various tools can be connected to the guiding device. During operation, the visibility of the working area should be limited as little as possible. The installation space of the guiding device should be as small as possible, and at the same time it should be possible to remove the tool. The guiding device should be conceived in such a way that it is possible to change the sanding material, when the tool is connected to the guiding device.

### DESCRIPTION OF THE INVENTION

On the basis of the invention, the abovementioned problems are intended to be solved better than in the case of conventional tools for surface treatment, which only provide a rigid operating state.

The abovementioned problems are solved by a guiding device, system and method according to the invention in accordance with the features of the independent claims. Preferred and advantageous configurations of the invention emerge from the subordinate claims which follow the independent claims, and will be described in more detail hereinafter.

According to the basic concept of the invention, at least two operating states are intended to be provided, wherein the tool can be securely fixed or set in the respective operating state or operating mode.

According to a first aspect of the invention, a guiding device for a tool for the surface treatment of a workpiece comprising at least one guide element, one angle device and one connection arrangement for connecting the guiding device to the tool is provided, wherein a predetermined angle between a plane or sliding plane of the at least one guide element and a plane of action of the connectable tool can be set by means of the angle device; and wherein the device is switchable between at least one flexible operating state and one rigid operating state.

In this way, the hardness, elasticity or rigidity of the guiding device can be altered. If the flexible operating state is chosen, for example, the desired flexibility for an intermediate lacquer sanding can be provided. With the aid of the angle device, a secure guidance of the tool can be guaranteed and thus toppling or tipping over, which of course may occur during handling of a tool on surfaces to be treated without an angle device, can be avoided.

The term “rigid operating state” should in particular be understood to mean that even when force is applied, by a person operating the tool, in the direction of the plane of action and thus generally in the direction of the workpiece to be treated or of the sanding surface, the predetermined angle is fixed. In contrast, the flexible operating state guarantees a limited movability of the plane of action relative to the plane of the at least one guide element i.e. of a sliding plane, guide plane or support plane.

“Tool for surface treatment” should in particular be understood to mean a tool such as a sanding or polishing appliance, which is provided in particular for sanding, intermediate lacquer sanding, polishing or the like.

According to a further aspect of the invention, the guiding device for a tool for surface treatment of a workpiece furthermore has a bracing element, which is designed to set the rigid operating state.

With the aid of the bracing element, a predetermined angle can be set precisely. If required, the bracing element can be attached to or positioned on the guiding device in such a way that a rigid, highly resilient guiding device is available. In this way, accurate tool guidance at the angle predetermined by the angle device can take place even when there is high pressing force against the surface or edge to be treated.

According to a further aspect of the invention, the connection arrangement has a cutout for the bracing element; wherein the bracing element has a rotatable eccentric body, which can be coupled to one end of a connection element running through the angle device and which is designed to engage in the cutout of the connection arrangement optionally with play or without play, in order to set the flexible operating state or the rigid operating state.

In this way, a choice can be made selectively between the rigid and the flexible operating state and thus optimal behaviour of the tool can be guaranteed during the surface treatment as a function of the treatment process. The switching from rigid or hard to soft and vice versa can take place rapidly manually using an eccentric body, for example using a suitable actuating element such as with a lever.

According to a further aspect of the invention, the guiding device furthermore has at least one elastic element for setting the flexible operating state, wherein the element is selected from a group comprising:

a spring, damping plate, bolt with at least one elastic section or a combination of said elastic elements.

In this way, advantageously a particularly gentle and accurate fine treatment of surfaces can be guaranteed. This predetermined flexibility can be used advantageously for work steps such as intermediate lacquer sanding, which require particularly sensitive and accurate guidance of the sanding appliance.

According to a further aspect of the invention, the angle device has a clamping system for fixing and releasing an angle, comprising a mechanical operating element selected from the group comprising: a screw connection, a clamping lever, a rotary knob or a latching mechanism.

In this way, users can securely set a large angular range, the angular range being preferably between 43° and 92°.

According to a further aspect of the invention, the guiding device according to any one of the preceding claims furthermore has at least one handle, which is arranged on the angle device or the connection arrangement or a transition region between the angle device and the connection arrangement and/or on the guide element on the side away from the guide plane.

The handle can be formed as a section that is comfortable to grip and optionally can have ergonomic formations, in order to improve the handling. In addition to a handle on the connection arrangement, a second handle can be arranged on the side of the guide element remote from the tool, for better guidance.

According to a further aspect of the invention, the handle has at least one longitudinally displaceable lengthening element, which can be brought into engagement with a mating element of the connection arrangement or of the angle device.

In this way, the handle region can be adapted and lengthened depending on the operator.

According to a further aspect of the invention, the angle device comprises a rail system.

By using a rail system, the desired angles can be adjusted simply. One advantage of using a rail system is that the working area can be seen clearly.

According to a further aspect of the invention, an element that can be displaced by a specific angle on at least one arcuate rail is formed as a handle with a clamping system.

Advantageously, markings of the angles to be set can be applied to the rail system. A predetermined or desired angle can be fixed or locked by means of the clamping system.

According to a further aspect of the invention, the clamping direction of the clamping system is arranged orthogonal to the sliding track of the rail and a first contact surface in the handle and a second contact surface in the rail system can be fixed by friction when the angle device is in the locked position.

In this way, a clamping element of the clamping system can be clamped against a track of the rail system, in order to produce a stable pairing of force.

According to a further aspect of the invention, the guide element has at least one guide plate with at least one roller element and/or with at least one elastic element.

According to a further aspect of the invention, the guide plate is mounted on the side facing the tool so as to be rotatable about an axis of rotation.

According to a further aspect of the invention, the guide element has at least one receptacle for a detachably attachable sliding plate, sliding structure, sliding woven fabric and/or sliding knitted fabric with a predetermined sliding property as a function of a workpiece surface.

According to a further aspect of the invention, a first axis of rotation of the angle device is arranged at the upper edge of the workpiece to be treated.

According to a further aspect of the invention, the guiding device, in the flexible operating mode, has an angular play of +/−10%, preferably +/−2% of the angle that can be set by the angle device.

According to a further aspect of the invention, the guiding device furthermore has a stop, which is preferably arranged between the angle device and the connection arrangement, in order to damp an end position of the angular play in the flexible operating mode.

In this way, the stop can be damped, in the flexible operating state, in the region of the end position of the pivot movement of the angle device in relation to the connection arrangement. In this case, the stop is preferably formed as an elastically deformable damping element, in order to softly damp the maximum pivot movement of the angle device and thus to avoid a hard stop. The damping element can be selected from the group comprising: thermoplastic polyurethane, elastomers, springs or other damping or flexible substances.

According to a further aspect of the invention, a system is provided, comprising a guiding device for a tool according to any one of the preceding aspects and a tool for surface treatment.

According to a further aspect of the system according to the invention, the tool is a hand-held or at least partially automatically guided electric sanding tool.

In this case, the electric sanding tool can be, for example, an orbital sander or delta sander or an eccentric sander or an oscillating multitool.

According to a further aspect of the system according to the invention, at least part of the guide element is displaceable into a position away from the plane of action, for changing the sanding material.

In this way, the complete system does not have to be taken apart in order to be able to change sanding material or sanding paper. This thus solves the problem whereby, otherwise, the sanding paper has to be guided through a narrow gap between the machine and the guide element or guide plate.

According to a further aspect of the invention, a method for the surface treatment of edge surfaces on workpieces is provided, the method comprising the following steps: Providing a guiding device of a tool with at least one guide element and one angle device, which is connected to a tool; setting a predetermined angle between the plane of the at least one guide element and a plane of action of the tool by means of the angle device; placing the at least one guide element of the guiding device onto a workpiece to be treated, with at least one edge; optionally setting a first flexible operating state, in which the plane of action of the tool, relative to the treatment plane, is movable for flexible adaptation to the edge surface to be treated or setting a second rigid operating state, in which a predetermined angle between the plane of at least one guide element and a plane of action of the connected tool is fixed.

According to a further aspect of the invention, a method for retrofitting a tool with a guiding device of the tool with at least one guide element; and an angle device is provided, which method comprises the following method steps:

Providing a guiding device for a tool with at least the guide element; and the angle device; and connecting the tool, for surface treatment, to the guiding device of the tool by means of a connection arrangement.

The connection of the machine can take place via the impact protection, for example. A screw connection is not absolutely necessary, if the form-fitting connection between the machine and the impact protection already has a high degree of rigidity. Additional attachment means such as screw connections can, however, advantageously prevent releasing of the machine from the impact protection, caused by vibrations or impacts, and can guarantee a secure connection of the tool to the connection arrangement during operation.

### BRIEF DESCRIPTION OF THE FIGURES

Further features and advantages of the invention emerge with reference to the following drawings in which advantageous exemplary embodiments of a guiding device according to the invention are depicted by way of example, without restricting the invention to the exemplary embodiments shown. In the drawings:

FIG. 1a shows a perspective view of an exemplary embodiment of the guiding device according to the invention with a guide element, which is mounted on the side facing the tool so as to be rotatable about an axis of rotation;

FIG. 1b shows a perspective detailed view of the guide element at the connection arrangement of the guiding device;

FIG. 2a shows a perspective view of a further exemplary embodiment of the guiding device according to the invention obliquely from above with a tool and a guide plate in the mounted-together state, or working position;

FIG. 2b shows a front view of the guiding device from FIG. 2a;

FIG. 2c shows a sectional view along the section A-A from FIG. 2a i.e. along the longitudinal axis of the handle of the guiding device;

FIG. 3 shows a perspective view of the guiding device shown in FIGS. 2a to 2c, without the tool;

FIG. 4 shows an exploded view of the guiding device shown in FIG. 3, without the tool;

FIG. 5a shows a lateral exploded view of the connection arrangement of the guiding device and a tool;

FIG. 5b shows a perspective exploded view of the retaining bracket of the connection arrangement and of the tool from FIG. 5a;

FIG. 6 shows a perspective view of a further exemplary embodiment of an upper retaining bracket of a connection arrangement;

FIG. 7 shows a perspective view of a further exemplary embodiment of the guiding device with a guide plate in the released state for changing the sanding material;

FIG. 8a shows a front view of the guiding device from FIG. 7;

FIG. 8b shows a sectional view along the section B-B from FIG. 8a;

FIG. 8c shows a perspective detailed view of the rotary knob with the clamping element;

FIG. 9 shows a lateral view of the guiding device with the tool and with the guide plate of the guide element in the released state for changing the sanding material;

FIG. 10a shows a lateral view of the guiding device without the tool;

FIG. 10b shows the sectional view along the section E-E from FIG. 10a in the rigid or fixed operating state;

FIG. 10c shows the sectional view along the section C-C from FIG. 10a;

FIG. 11a shows a guiding device in the flexible operating state without a tool;

FIG. 11b shows the sectional view along the section D-D from FIG. 11a;

FIG. 12 shows a guiding device in the rigid operating state with the tool with a fixed flat angle;

FIG. 13 shows a guiding device in the rigid operating state with the tool with a further angle setting by way of example;

FIG. 14 shows a method according to the invention provided for the surface treatment of edge surfaces on workpieces; and

FIG. 15 shows a method for retrofitting a tool.

The depictions are diagrammatic and are not necessarily true to scale. Furthermore, they do not show all details but rather are partially restricted to the depiction of the details which are essential to the invention and of further features which facilitate the explanation and description of the invention. Identical elements in the different figures are labelled with identical reference symbols. In the following description of the figures, different spatial or terms are specified in relation to directions. It is pointed out that terms such as top, bottom, vertical, horizontal or first, second and third are used for better understanding of the figures, but do not restrict the exemplary embodiments to the specified terms.

### DETAILED DESCRIPTION OF THE FIGURES

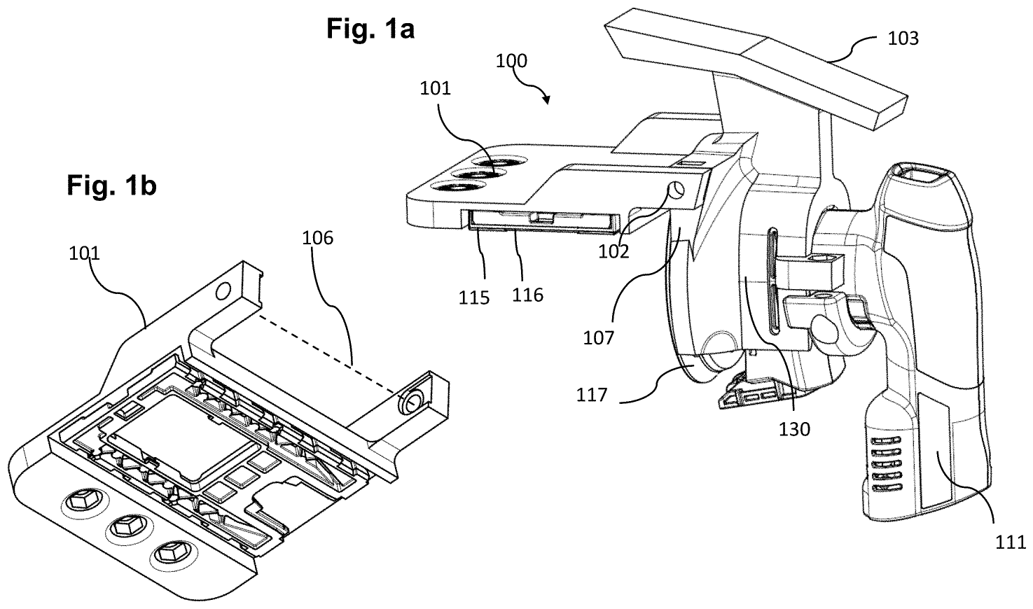

FIG. 1a shows a perspective view of a first exemplary embodiment of the guiding device 100 according to the invention. The guiding device has an impact protection 107 or protector, which is preferably formed circumferentially and serves, on the one hand, to protect the sanding disc 117 and thus the drive of the tool and on the other to protect hand surfaces or an operator. In the embodiment shown in FIG. 1a, the guide plate 115, and the guide element 101, are attached to the impact protection 107 of the tool 111. In this embodiment, the interface between the guide element 101 and the impact protection 107 can be used as an angle device, as the guide plate is mounted in a rotatable manner. In other words, the guiding device 100 has a guide element 101, which is mounted on the side facing the tool 111, rotatable about an axis of rotation 106.

In this way, the axis of rotation 106 can be arranged close to the plane of action of the sanding disc 117 substantially at the level of the impact protection 107. The tool 111 with the sanding disc 117 is designed for surface treatment and, with the position of the axis of rotation arranged in this way, can in particular treat edges with an even and accurate sanding pattern.

By means of a connection arrangement 130, the tool 111 is connected to the guiding device 100 in such a way that the tool 111 is arranged vertically in relation to the plane of the guide plates. Other arrangements such as a horizontal or angled position of the tool 111 are conceivable, as long as the centre of gravity position of the attached tool prevents, as far as possible, the guiding device from tipping over. A handle upper part 103 is provided for improved handling of the guiding device.

In the embodiment shown, the connection arrangement 130 is used, on the one hand, to retain the handle 103 and on the other hand to retain the impact protection 107. The handle 103 can also be adapted ergonomically to the hand and other designs of the handle, not shown, can be realised. Depending on the tools to be connected, the advantageous form-fitting connection to the connection arrangement 130 can be configured differently than in FIG. 1a.

In FIG. 1b, the guide plate or the guide element 101 is shown in detail obliquely from below and the axis of rotation for angle setting is shown as a dashed line with the reference symbol 106. The guide element 101 has a guide plate 115, which has a running base 116 on the lower section. The running base can be made of a soft material such as suede or similar, for example. The running base is exchangeable as a function of different surfaces and can be formed to be not only soft but also hard or wear-resistant.

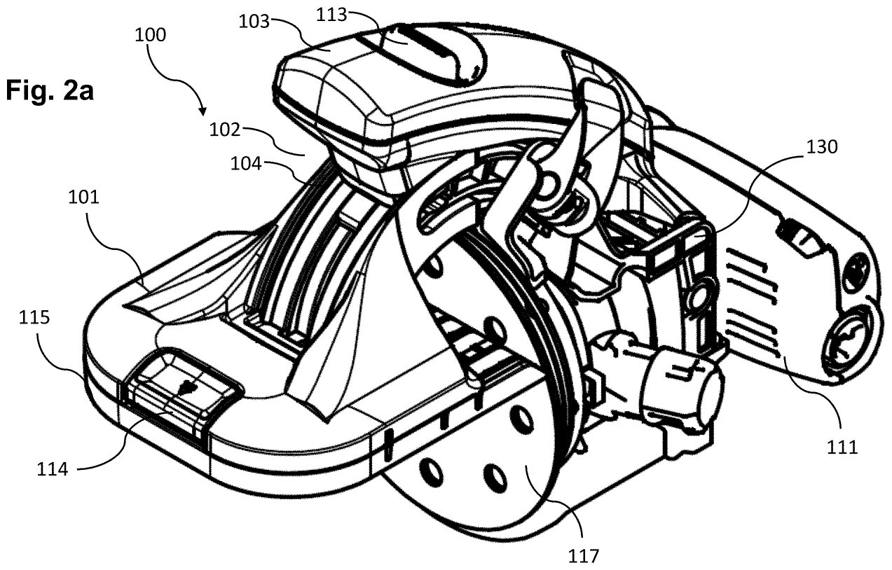

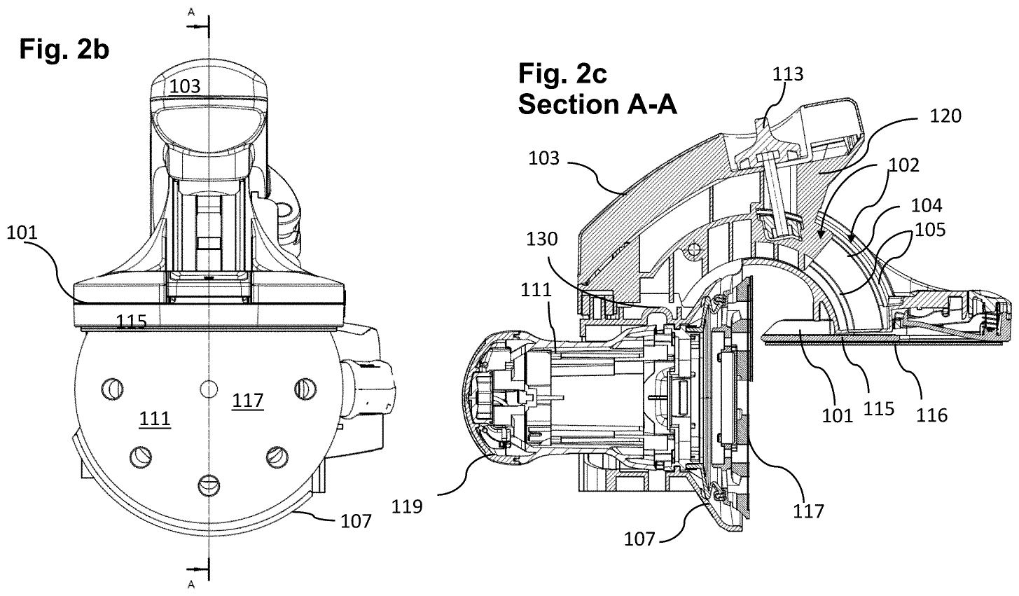

FIG. 2a shows a perspective view of a further exemplary embodiment of the guiding device 100 according to the invention obliquely from above with a tool. This embodiment has an alternative handle geometry than in FIG. 1a. The handle 103 or the handle upper part is connected not only to the connection arrangement 130, but also to the angle device 102. In order to set desired angles, a rail system is used here and a displaceable angle retainer 104. Thus, this guiding device has a virtual point of rotation or axis of rotation.

The structure of the rail system is divided into the following three component groups:

### First Group 101:

The guide element 101, which has a guide plate 110. Furthermore, the guide element 101 has a receptacle for the rails arranged in the handle 103.

### Second Group 120:

The handle region 103, which has, in the lower part, rails and arcuate guide tracks 105 which can be brought into engagement with the receiving rails of the guide element, as shown for example in the section A-A from FIG. 2c.

### Third Group 130:

The connection arrangement 130 connects the handle assembly (2nd group) to the tool 111.

FIG. 2b shows a front view of the guiding device from FIG. 2a. In this view, in particular the sanding disc 117 of the tool 111 can be seen. Furthermore, in FIG. 2b the section A-A is indicated, which goes along the centre axis of the handle 103 and the centre axis of the guide element 101 and the guide plate 115.

This section A-A is shown in FIG. 2c. FIG. 2c shows the tool 111 with a dedicated handle region 119 and the sanding disc 117. The impact protection 107 is located close to the sanding disc 117 and is part of the connection arrangement 130. The connection arrangement 130 connects the handle assembly 120 to the tool 111.

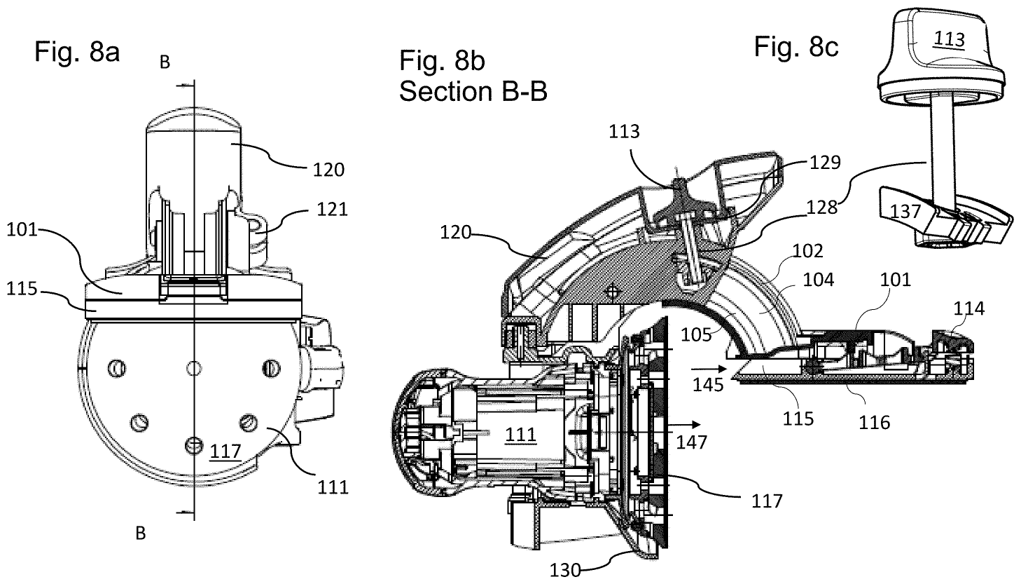

The guide element 101 with the guide plate 115 and sliding base 116 is connected to the handle assembly 120 by means of the rail system. The angle device 102 is formed as a rail system, which has displaceable angle retainers 104 and arcuate guide tracks 105. A predetermined angle is securely settable by means of the rotary knob 113 inserted in the handle upper part 103 and a counter bearing 137 (shown in full in FIG. 8c), which clamps the rail system. In the example shown, the chosen angle is approximately 90°.

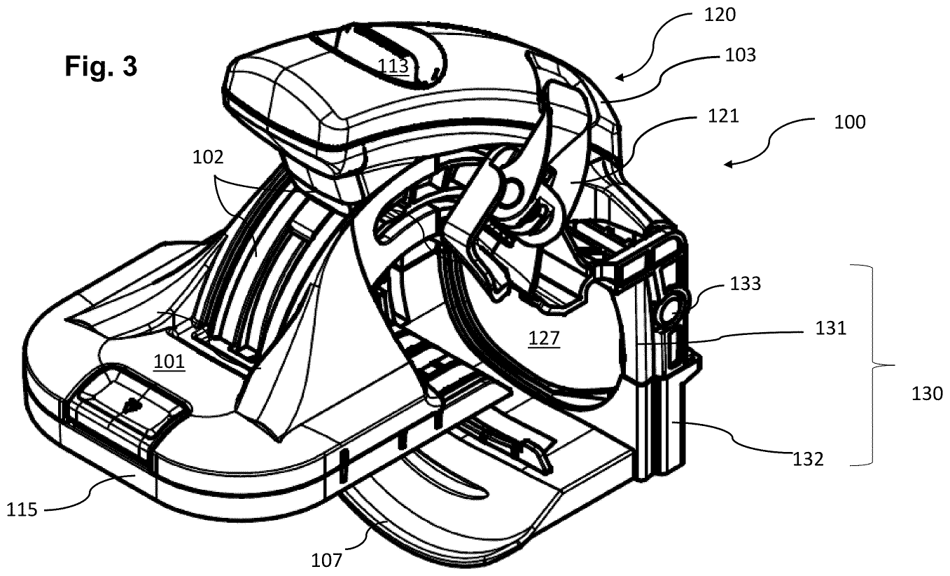

FIG. 3 shows a perspective view of the guiding device 100 shown in FIGS. 2a to 2c, without a tool. This view shows the connection arrangement 130 and its components or component groups 101, 120 and 130. In the connection arrangement 130, the reference symbol 131 denotes the upper retaining bracket for the tool (not shown), while 132 indicates the lower retaining bracket with the impact protection 107. In the variant shown, the retaining brackets 131 and 132 form an oval receptacle 127 with a groove or ribs in which the tool or the tool neck can be received in a form-fitting manner and on both sides. Depending on the form of the tool to be received, the form of the receptacle 127 or the form of one or more grooves and/or form-fitting ribs can vary. In this way, a rigid and secure connection to a tool or a machine can take place. To receive the tool (cf. FIG. 2a, which shows a tool connection), the lower retaining bracket 132 can be released from the upper retaining bracket 131.

The centre axis of the pivot bearing 133 forms the pivot axis about which the handle assembly 120 of the guiding device is mounted in a pivotable manner in the flexible operating mode. The pivot axis preferably lies close to or in the sectional axis of the centre plane of the workpiece to be treated and of the vertically arranged Z plane through the centre of gravity of the guiding device. The angular play for the flexible operating mode can optionally be allowed or not allowed by the clamping element 121 depending on the position. The angle device 102 can be set at a predetermined angle using the rotary knob 113.

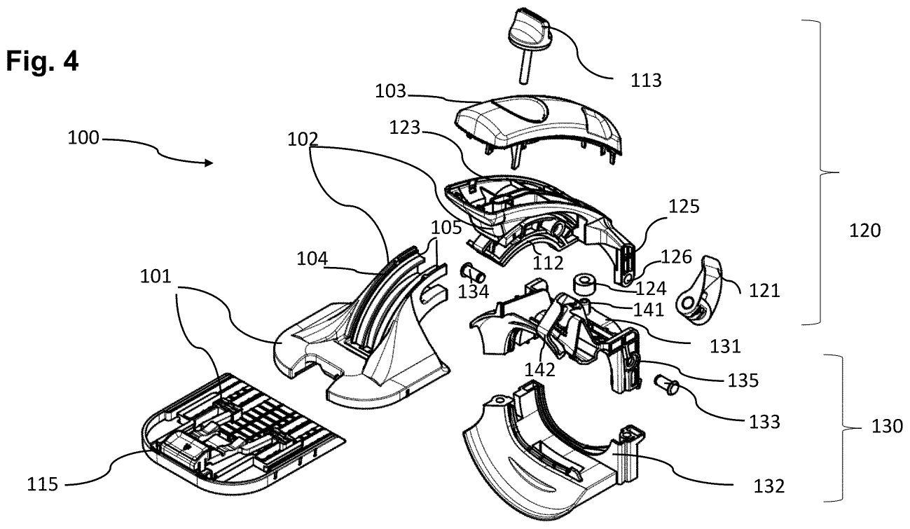

FIG. 4 shows an exploded view in the guiding device shown in FIG. 3. The first assembly of the guide element 101 has, on the lower side, the introducible guide plate 115 and sliding elements. Optionally, roller elements or elastic elements can be attached to the lower side of this guide plate 115. Furthermore, the guide plate 115 can have, on the lower side, a receptacle for releasable and attachable elements which are selected from the group comprising: sliding base 116, sliding structure, sliding woven fabric, sliding knitted fabric and a combination of said elements.

The rail system for the angle device 102 is arranged on the upper side of the guide element 101 centrally and on the side facing the connection arrangement. This rail system has the displaceable angle retainer 104 and the arcuate guide tracks 105. The guide tracks 105 can engage in the second assembly 120, i.e. in particular in the rails 112 of the angle device 102. The handle region is arranged above the rail system of the angle device 102, with a handle upper part 103 and a handle lower part 123. The handle assembly 120 can be secured using the rotary knob 113 and a mating element guided in the rail system (see reference symbol 137 in FIG. 8c).

Furthermore, the handle assembly 120 has, at its lower end, a retaining device 125 that is configured to receive the pivot bearing 133 in the receptacle 126. With the aid of the pivot bearings 133 and 134, the retaining device 125 of the handle assembly 120 is connectable to the connection arrangement 130. By means of the clamping element 121, a pivotability of the handle assembly 120 can be set in relation to the connection arrangement 130 in the flexible operating mode.

The third assembly of the connection arrangement 130 has, as described previously, the upper and lower retaining brackets 131, 132. The upper retaining bracket has a receptacle 135 for the pivot bearing 133. A receptacle (not shown) for a further pivot bearing 134 is also provided on the opposite side. A retaining element 141 in the form of a pin is provided on the rear edge of the upper retaining bracket 131. This pin 141 can receive the damping element 124. This damping element 124 serves as a stop, in order to damp an end position of the angular play in the flexible operating mode of the guiding device 100. Furthermore, the retaining bracket 131 has, on the upper side, a receptacle 142 for the clamping element 121.

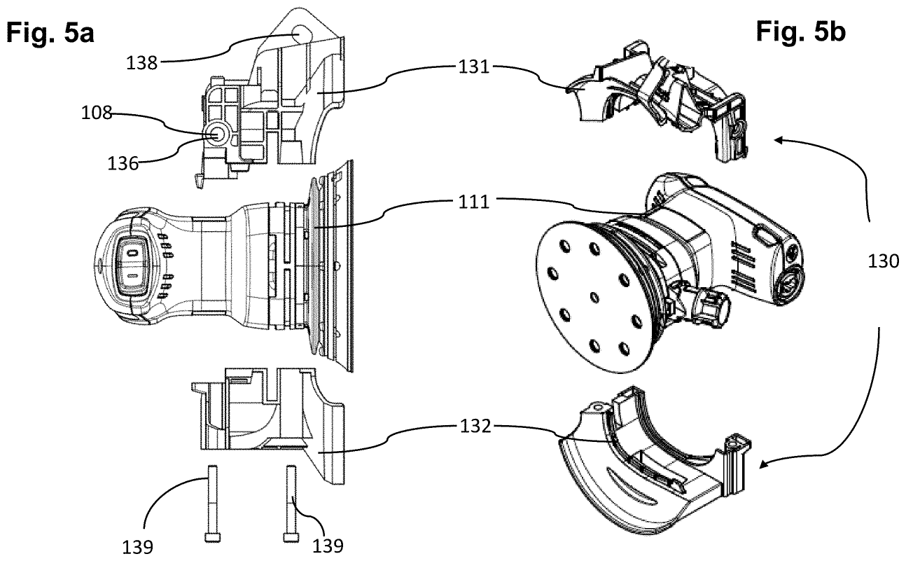

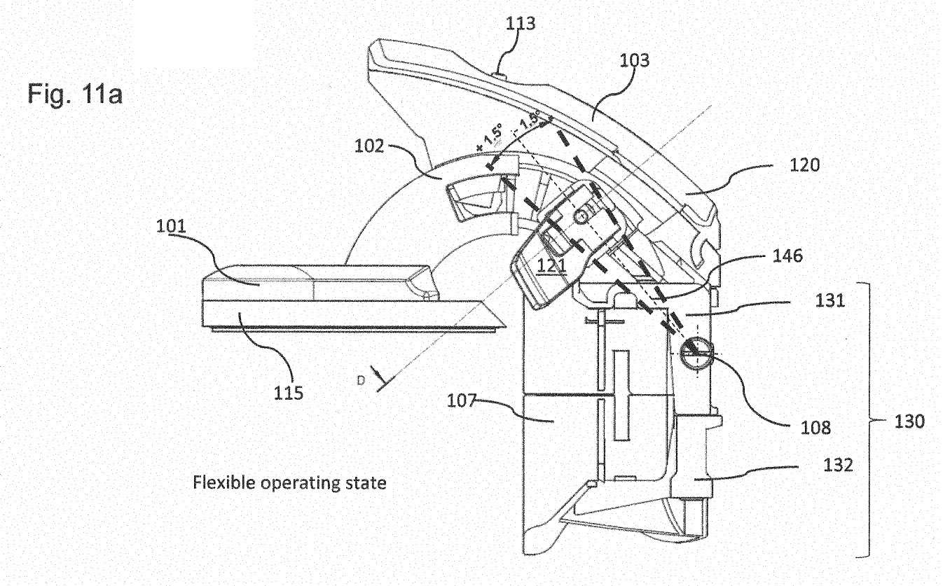

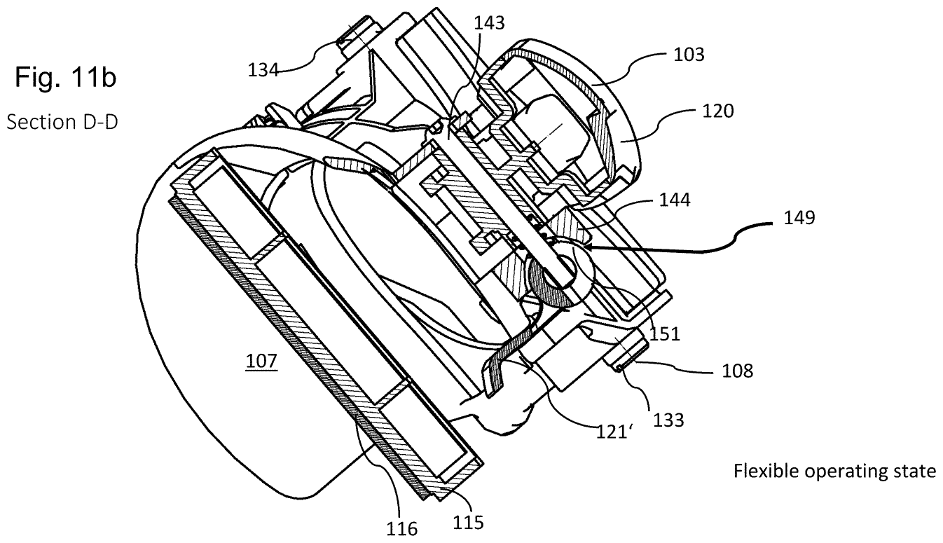

FIG. 5a and FIG. 5b show only the third assembly or the connection arrangement 130 in the non-mounted state with a tool 111. The upper retaining bracket 131 has an elongated hole 138 on the upper side. In the flexible operating mode, an angular play about the pivot axis 108 is made possible. For example, FIG. 11a illustrates how an angular play is made possible by means of an appropriate position of an eccentric lever.

FIG. 5a additionally shows the receptacle 136 for the pivot bearing 135 shown in FIG. 4.

The lower retaining bracket 132 can be connected to the upper retaining bracket 131 by means of the connecting elements 139 after introduction of the tool. These connecting elements 139 can be screw connections, for example, and ensure secure retention when there are vibrations, as occur during operation.

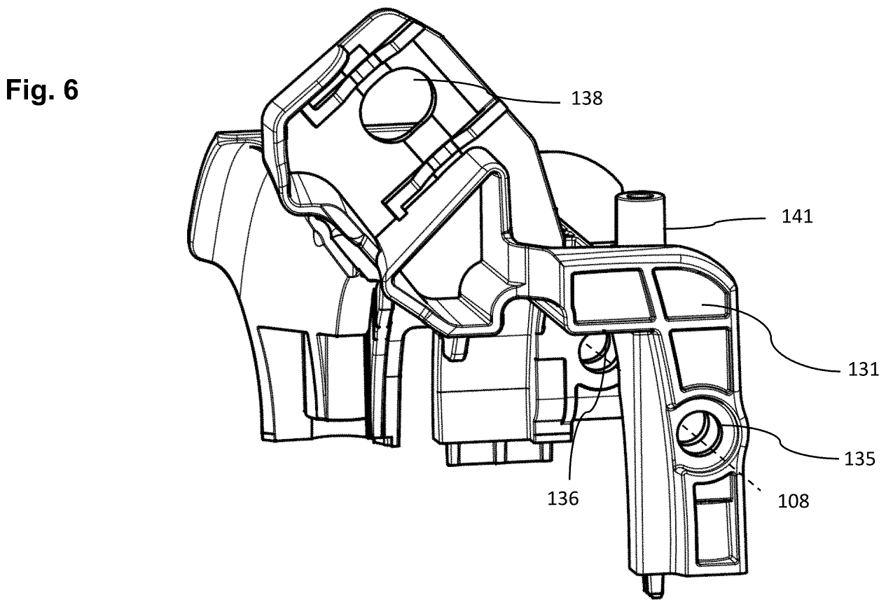

FIG. 6 shows a perspective view of a further exemplary embodiment of an upper retaining bracket 131 of a connection arrangement 130. Both receptacles 135, 136 for the pivot bearings 134 and 133, which are not shown, can be seen in this perspective depiction. In addition, a retaining element 141 or pin for receiving a damping element or damping stop 124 can be seen. Furthermore, the elongated hole 138 which enables or limits the pivotability in the flexible operating mode is also depicted here. The axis of rotation or pivot axis 108 of the connectable tool is depicted by the dashed line 108; which runs centrally through the receptacles 135, 136.

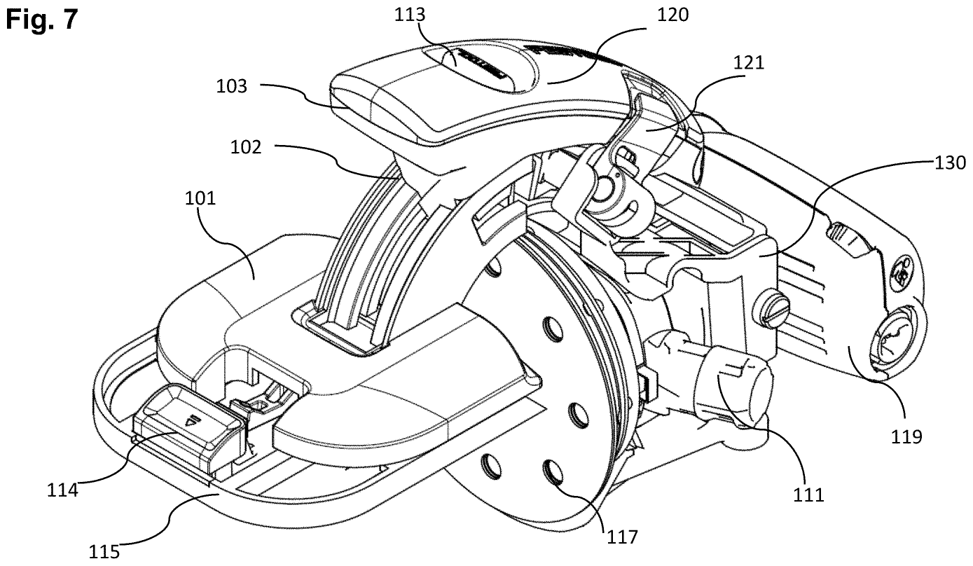

FIG. 7 shows a perspective view of a further exemplary embodiment of the guiding device with a guide plate 115 in the released state. This released state is suitable for changing the sanding material. With the aid of the actuating element 114 or a push-button, the guide plate 115 can be displaced from the upper part of the guide element 101 away from the tool. In this way, the tool 111 does not have to be taken out of the connection arrangement 130 alongside its handle or the sanding material 117 and time can be saved during changing of the sanding material.

A further advantage of the displaceability of the guide plate is that the angle device does not have to be released in order to change the sanding material, but rather the set position of the handle assembly 120 in relation to the angle retainer can remain the same. In other words, after a change of sanding material, the previous angle position can still be used and an accurate treatment of the surface or the edge can thus take place.

The embodiment shown in FIG. 7 shows a clamping element 121, which has a different geometry than, for example, the example shown in FIG. 4. Several variants of the geometry for the clamping elements 121 and the rotary knob 113 are possible. Instead of the rotary knob 113, a mechanical operating element, for example, can be selected from the group comprising a screw connection, a clamping lever, an eccentric clamp or a latching mechanism as the clamping system for fixing and releasing the predeterminable angle.

FIG. 8a shows a front view of the guiding device, with the guide plate released. In this view, in particular the sanding disc 117 of the tool 111 can be seen in the lower section. Furthermore, in FIG. 8a the section B-B is indicated, which goes along the centre axis of the handle assembly 120 and the centre axis of the guide element 101 and the guide plate 115.

FIG. 8b shows the section B-B shown in FIG. 8a. The position of the guide plate 115 shown in FIG. 8b is the released position of the guide plate 115. After the push-button or the actuating element 114 has been actuated, a displacement movement for releasing the guide plate 115 can be carried out in the direction of the arrow 145. After the displacement of the guide plate 115, there is sufficient space between the tool-side end of the guide plate 115 and the sanding material 117 to change the sanding material. The removal of the sanding material is shown here by the arrow 147.

The connection arrangement 130 is formed in such a way that the form-fitting connection between the machine and the connection arrangement 130 has a high degree of rigidity. The wall thicknesses of the components should not be greater than 4 mm, for example, so that these components can be manufactured by an injection moulding method without difficulty. At the same time, the wall thicknesses are chosen in such a way that the rigidity of the final product is guaranteed. The depicted drawing is not true to scale and other wall thicknesses may also be conceivable, as long as they fulfil the necessary rigidity requirements. It is advantageous if the material of the guiding device is chosen in such a way that the flexible angle setting, and thus the softness, is not dependent upon the material.

The exemplary embodiment depicted in FIG. 8b shows that a change of sanding material is possible without adjusting the angle device 102. The firm angle setting is easily settable by means of the rotary handle 113. It is settable manually by rotation with the aid of a clamping mechanism. This clamping mechanism between the handle upper part and the rail system of the angle device 102 can be provided by various variants. In the variant shown in FIG. 8a, an eccentric lever 212 is provided as the clamping mechanism for the various operating modes.

FIG. 8c shows the clamping mechanism of the rail system i.e. the rotary knob 113 from FIG. 8b in a perspective detailed view. The rotary knob 113 is connectable to a threaded rod 128 and to a mating element 137. The mating element 137 functions as a clamping element or pressure disc and can produce the required tension via the rotary movement of the rotary knob 113. In this case, for the clamping, the pressure disc or mating element 137 is pressed against an arcuate guide track of the rail system. In this way, the angle retainer 104 can be connected securely to the handle assembly 120.

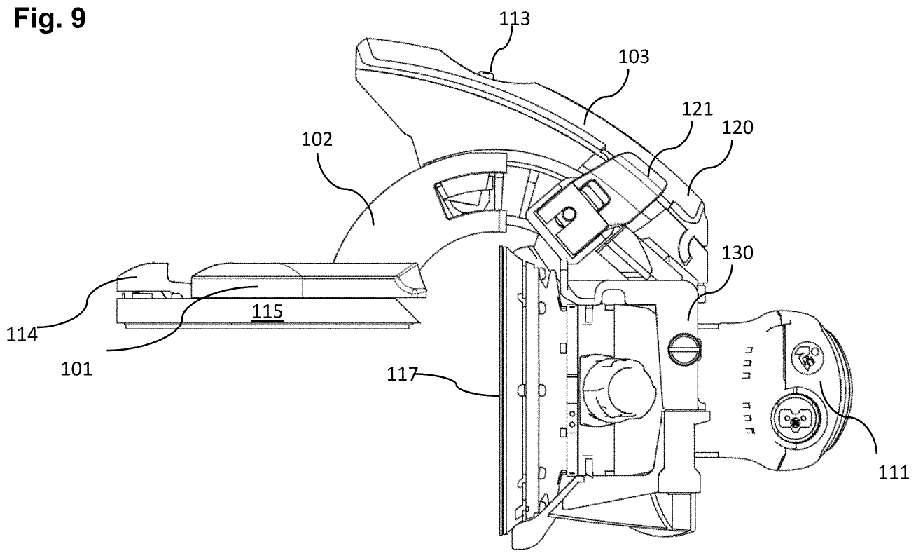

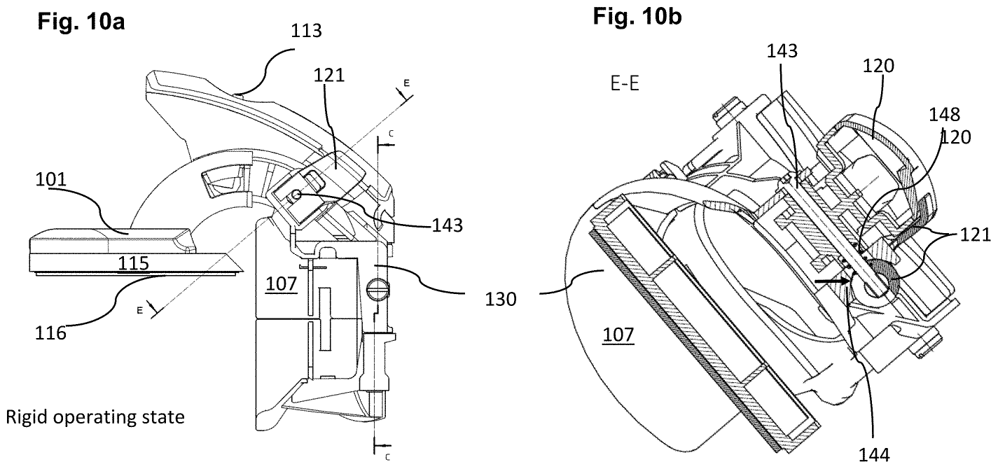

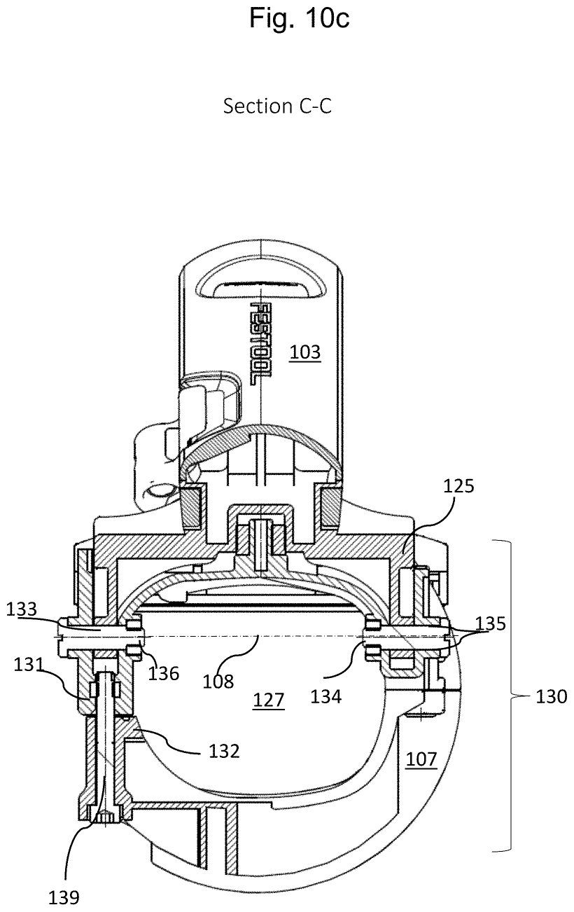

FIG. 9 shows a lateral view of the guiding device with the tool 111 and with the guide plate 115. FIG. 9 shows the released state for changing the sanding material. The sanding material 117 has enough space to be exchanged. In the following figures, FIGS. 10a and 10b, details of the guiding device shown in FIG. 9 are shown without the tool 111.

FIG. 10a shows the guiding device from FIG. 9 in the mounted-together state, i.e. the guide plate 115 is now arranged substantially closer to the impact protection 107 than in the released position previously shown in FIG. 9. FIG. 10a shows an eccentric lever 121, which is situated in the clamped position and thus produces a rigid operating state. FIG. 10a indicates the section E-E, which is shown in FIG. 10b.

FIG. 10b is the section E-E, which has been applied through the clamping screw 143. The clamping screw 143 can optionally have an elastic spring element, such as a spring 148, for example. With the clamping screw 143 and the shown spring element 148, the system can be clamped, i.e. the rail system 120 can be securely connected to the connection arrangement 130. The eccentric lever 121 is used in the position shown in FIG. 10b to establish the handle assembly in relation to the connection arrangement. There follows a clamping of the eccentric lever 121 against the mating element 144. In the shown position FIG. 10b of the eccentric lever 121, the clamping surface of the eccentric lever 121 lies against the mating surface of the mating element 144, such that the guiding device is situated in the rigid operating state. The pairing of force between the mating element 144 and the clamping element 121 arising in the clamped state is shown here diagrammatically with an arrow.

FIG. 10c shows the section C-C, of the guiding device shown in FIG. 10a in the rigid operating state. In the lower half of FIG. 10c, the connection arrangement 130 with the upper retaining bracket 131 and the lower retaining bracket 132 and the impact protection 107 can be seen. The retaining brackets 131, 132 are held together by the connecting element 139. This can be a screw, for example, as in the example shown.

The section C-C shows the axis of rotation 108 of the tool, the axis of rotation of the tool being identified here by a dash-dotted line. This axis runs in the middle centrally through the pivot bearings 133 and 134, which are received by the respective receptacles (135, 136). A rotatability about the axis of rotation is, however, blocked in the rigid operating state. In the rigid operating state, the retaining device 125 is not pivotable in relation to the assembly of the connection arrangement 130. In contrast to this, the following FIG. 11a shows the flexible operating state.

FIG. 11a shows a guiding device in the flexible operating state without a tool. In the flexible operating state, the guide plate 115 can react flexibly in relation to the plane of action of a tool (not shown here) during the surface treatment. Flexibility is depicted diagrammatically in FIG. 11a with the bold dashed lines, which intersect in the axis of rotation 108.

In the flexible operating state, the eccentric lever 121 is tilted in the direction of the guide plate in the variant shown here. In this position, the assembly of the handle 120 and the guide element 101 can be pivoted in relation to the connection arrangement 130. The pivotability about the axis of rotation 108 is, respectively, +1.5° towards the centre axis 146 and −1.5 degrees away from the centre axis (see arrows). The eccentric lever 121 allows a movement or a play around said number of degrees. Alternatively, larger angular ranges such as +/−10° can be set up when there is a correspondingly greater spacing from the mating element 144 to the respective mating surfaces 151 of the eccentric lever 121. This spacing or play 149 is shown in detail in the sectional depiction D-D respectively in FIG. 11b.

FIG. 11b shows the section D-D, where the eccentric lever 121′ has been moved in the direction of the guide plate. In the example shown, a flexible operating state is realised in the case of this eccentric lever position 121′. In the present exemplary embodiment, there is no contact with the mating elements 144 in this position of the eccentric lever 121′. In other words, a play 149 between the mating surface 151 of the eccentric lever 121′ and the mating element 144 is allowed and thus the flexible operating state is achieved. As a result of the play, the guide plate 115 and the assembly of the handle 120 attached therein can be pivoted about the axis of rotation 108. As shown in the previous figures, the pivoting about the pivot bearings 133 and 134 is realised.

The guide plate 115 has a running zone or sliding zone, which can be made of suede for example. In this way, sensitive surfaces can be protected.

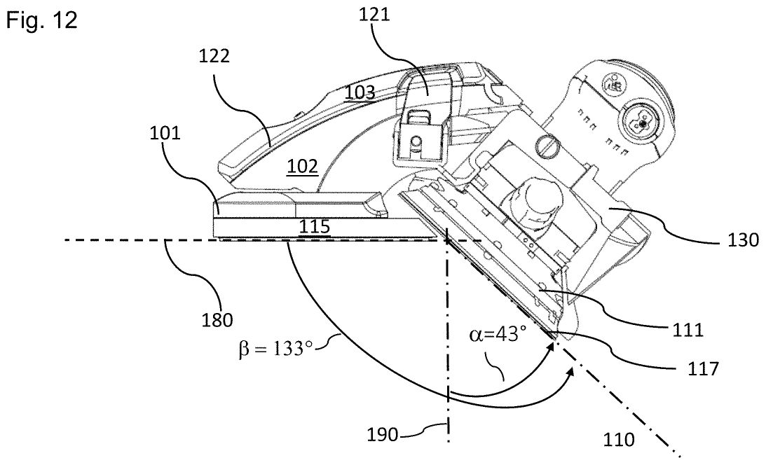

FIG. 12 shows a guiding device in the rigid operating state, where the eccentric lever 21 is positioned in the corresponding receptacle in the handle region 103. In the rigid operating state, it is particularly important to maintain the prescribed angles reliably. In this case, an angle β of 133° between the edge surface to be treated and the guide plane 180 is desired. The plane of action or treatment plane of the sanding disc 117 of the tool 111 is identified here by a dash-dotted line 110. If an edge with this angularity is being treated, an angle α of 43° can be produced in relation to the vertical with the reference symbol 190.

At these obtuse angles, the angle retainer 104 can no longer be seen, since the rail system has been pushed together in such a way that said angle retainer 104 is covered by the exterior of the rail system (see reference symbol 102) of the handle assembly 120.

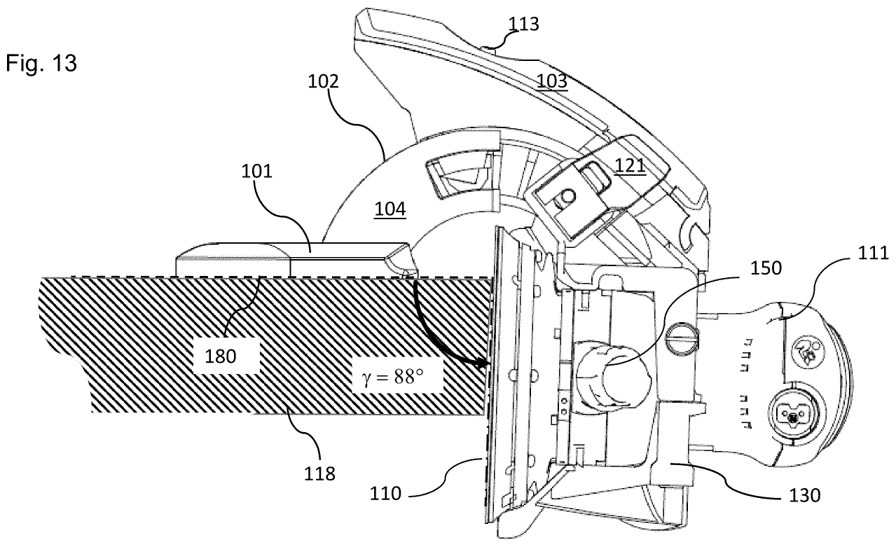

FIG. 13 shows a further exemplary embodiment in the rigid operating state, where a different angularity has been chosen and a workpiece 118 to be treated is shown. The angle retainer 104 is visible in this case, since a smaller angle is set. The desired angle γ is 88° and identified by the arrow. The workpiece 118 is only partially depicted and is preferably a plate, which can be made of various materials such as wood and where applicable already has a coat of lacquer. The treatment plane is identified by the dash-dotted line and shows the plane of action 110 of the tool 111, in which the sanding disc acts upon the workpiece 118. In order to collect abraded particles which accumulate during the treatment, the tool 111 advantageously generally has a suction apparatus. The depicted tool 111 shows, for example, a connector 150 for abraded-particle collecting containers, in order to enable treatment during sanding with as little dust as possible. This is advantageous in particular in the case of fine sanding work.

The angle γ=88° chosen here is fixed by the appropriate rotation of the rotary knob 113. In this way, the desired angle can be securely set in a reliable manner. By flipping the eccentric lever 121, a switch can be made simply from the fixed operating state into the flexible operating state. In the soft or flexible operating state, methods such as intermediate lacquer sanding can be performed.

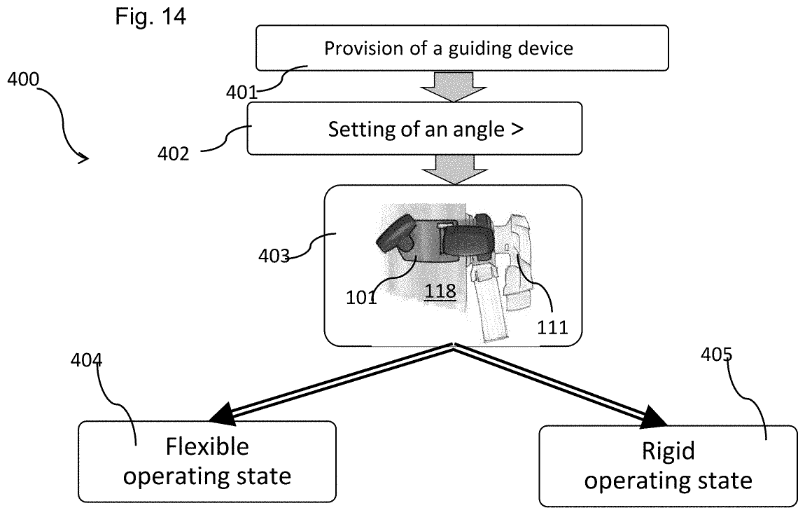

FIG. 14 shows a method for the surface treatment of edge surfaces on workpieces 400. This method comprises the following steps: The first method step 401 is the provision of a guiding device for a tool with at least one guide element and one angle device, which is connected to a tool 111.

A further method step is the setting 402 of a predetermined angle between the plane of the at least one guide element and a plane of action of the tool by means of the angle device.

As a further method step 403, the method comprises the placing of the at least one guide element of the guiding device onto a workpiece to be treated, with at least one edge. In the depicted sketch of the method step 403, two handles (one on the guide element and one at the level of the edge) are provided above the workpiece. Using the handle on the guide element, tipping-over of the tool 111 with the suction apparatus after it has been put in place can be prevented.

The operator can choose between two different operating states in the next method step. In method step 404, he can set the flexible operating state (404), in which the plane of action of the tool, relative to the treatment plane, is movable for flexible adaptation to the edge surface to be treated. Alternatively, the operator can set a rigid operating state in method step 405.

In the rigid operating state, a predetermined angle between the plane of at least one guide element and a plane of action of the connected tool is fixed. In this way, accurate work can be carried out. If the sanding material is used up, a further method step 406 can be carried out, in which the guide plate is displaced in such a way that easy access to the sanding material is provided and thus the sanding material can be changed easily.

In contrast to the rigid operating state, where there is a fixed connection between said planes, in the flexible operating state flexible adaptation to the geometry of the tool is possible. This mode of operation is suitable in particular for intermediate lacquer sanding. The intermediate lacquer sanding is the sanding that is performed after the first lacquering. By means of the guiding device according to the invention, a very even sanding pattern and a precisely smoothed surface and low sanding tolerance advantageously can be provided. In the flexible operating state, advantageously a damping element can be provided, which damps the movement by the operator upon maximum run-out downwards.

With the present guiding device, relatively small angular plays of +/−1.5° can be set and thus unintentional damage to the surface can be avoided. Smoothed surfaces of very good quality can be achieved.

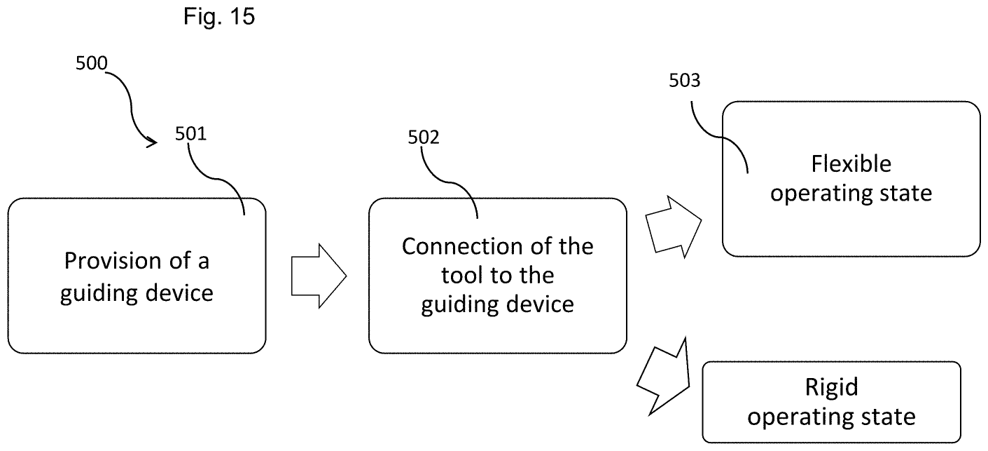

Furthermore, the invention and the guiding device are designed to retrofit tools with a guiding device. FIG. 15 diagrammatically shows the method steps of the retrofitting method 500. In method step 501, the retrofitting method 501 initially provides a guiding device. The method step 502 comprises the connecting of the tool to the guiding device. For this purpose, the guiding device comprises a connection arrangement, which has a suitable receptacle, in order to connect, preferably in a form-fitting manner, the tool to be retrofitted. Secure retention can optionally be guaranteed by screw connections.

After the connection, the connected tool can optionally be run in the rigid operating state (504) or in the flexible operating state (503).

### LIST OF REFERENCE SYMBOLS

100 guiding device
101 guide element
102 angle device
103 handle or handle upper part
104 displaceable angle retainer
105 arcuate guide track of the rail system
106 axis of rotation for angle setting
107 impact protection
108 axis of rotation of the tool in the flexible operating state
110 plane of action/treatment plane
111 tool for surface treatment
112 rail of the angle device formed as a rail system
113 rotary knob
114 actuating element or push-button
115 guide plate
116 running base or sliding base
117 sanding disc
118 workpiece
119 handle of the tool
120 handle assembly
121 clamping element
123 handle lower part
124 damping element
125 retaining device with receptacle for pivot bearing
126 receptacle for pivot bearing
127 receptacle for tool
128 threaded rod
129 recess in the handle
130 connection arrangement
131 upper retaining bracket
132 lower retaining bracket
133 pivot bearing on clamping element side
134 further pivot bearing
135 receptacle for pivot bearing
136 opposing receptacle
137 mating element or clamping element for rotary knob 113
138 elongated hole
139 connecting elements between retaining brackets 131 and 132
141 retaining element for damping element 124 or stop
142 receptacle for the clamping element 121
143 connecting element or clamping screw
144 mating element for eccentric lever
145 displacement movement for releasing the guide plate 115
146 centre axis
147 change of sanding material
148 spring element
149 play between mating element and eccentric mating surface
150 connector for abraded-particle collecting container
151 mating surface of the eccentric lever
180 plane of the guide element 101 or sliding plane of the sliding plate 115
190 vertical
α acute angle in relation to the vertical
β obtuse angle
γ angle between plane of action 110 and sliding plane 180

What is claimed is:

1. A guiding device for a tool for the surface treatment of a workpiece comprising
at least one guide element;
one angle device; and
one connection arrangement for connecting the guiding device to the tool;
wherein a predetermined angle between the plane of the at least one guide element and a plane of action of the connectable tool can be set by the angle device; and
wherein the guiding device is switchable between at least one flexible operating state and one rigid operating state.

2. The guiding device according to claim 1, furthermore having a bracing element, which is designed to set at least the rigid operating state.

3. The guiding device according to claim 2, wherein the connection arrangement has a cutout for the bracing element; and
wherein the bracing element has a rotatable eccentric body, which can be coupled to one end of a connection element running through the angle device and which is designed to engage in the cutout of the connection arrangement optionally with play or without play, in order to set the flexible operating state or the rigid operating state.

4. The guiding device according to claim 1, furthermore having at least one elastic element for setting the flexible operating state, wherein the element is selected from a group comprising:
a spring, damping plate, bolt with at least one elastic section or a combination of said elastic elements.

5. The guiding device according to claim 1, wherein the angle device has a clamping system for fixing and releasing an angle, comprising a mechanical operating element selected from the group comprising:
a screw connection, a clamping lever, a rotary knob or a latching mechanism.

6. The guiding device according to claim 1, further comprising at least one handle, which is arranged on the angle device or the connection arrangement or a transition region between the angle device and the connection arrangement and/or on the guide element on the side away from the guide plane.

7. The guiding device according to claim 6, wherein the handle has at least one longitudinally displaceable lengthening element, which can be brought into engagement with a mating element of the connection arrangement or of the angle device.

8. The guiding device according to claim 1, wherein the angle device comprises a rail system.

9. The guiding device according to claim 8, wherein an element that can be displaced by a specific angle on at least one arcuate rail is formed as a handle with a clamping system.

10. The guiding device according to claim 9, wherein the clamping direction of the clamping system is arranged orthogonal to the sliding track of the rail and a first contact surface in the handle and a second contact surface in the rail system can be fixed by friction when the angle device is in the locked position.

11. The guiding device according to claim 1, wherein the guide element has at least one guide plate with at least one roller element and/or with at least one elastic element.

12. The guiding device according to claim 1, wherein the guide element is mounted on the side facing the tool so as to be rotatable about an axis of rotation.

13. The guiding device according to claim 1, wherein the guide element or guide plate has at least one receptacle for a detachably attachable sliding base sliding structure, sliding woven fabric and/or sliding knitted fabric with a predetermined sliding property as a function of a workpiece surface.

14. The guiding device according to claim 1, wherein an axis of rotation of the angle device is arranged at the upper edge of the workpiece to be treated.

15. The guiding device according to claim 1, wherein the guiding device, in the flexible operating mode, has an angular play of +/−10% of the angle that can be set by the angle device.

16. The guiding device according to claim 15, wherein the guiding device furthermore has a stop, in order to damp an end position of the angular play.

17. A system comprising a guiding device for a tool according to claim 1 and a tool for surface treatment.

18. The system according to claim 17, wherein the tool is a hand-held or at least partially automatically guided electric sanding tool.

19. The system according to claim 17, wherein at least part of the guide element formed as a guide plate is displaceable into a position away from the plane of action, for changing the sanding material.

20. A method for the surface treatment of edge surfaces on workpieces comprising the following steps:
providing a guiding device of a tool with at least one guide element and one angle device which is connected to a tool;
setting a predetermined angle between the plane of the at least one guide element and a plane of action of the tool by the angle device;
placing the at least one guide element of the guiding device onto a workpiece to be treated, with at least one edge;
optionally setting a flexible operating state, in which the plane of action of the tool, relative to the treatment plane, is movable for flexible adaptation to the edge surface to be treated;
or
setting a rigid operating state, in which a predetermined angle between the plane of at least one guide element and a plane of action of the connected tool is fixed.

21. A method for retrofitting a tool with a guiding device of the tool with at least one guide element; and an angle device comprising the following steps:
providing a guiding device for a tool with at least the guide element; and the angle device; and
connecting the tool, for surface treatment, to the guiding device of the tool by a connection arrangement.
